(19) United States
(12) Patent Application Publication
(10) Pub. No.: US 2022/0071437 A1
(43) Pub. Date: Mar. 10, 2022

(54) DRAWING-TYPE COFFEE MACHINE

(71) Applicant: Cheng Uei Precision Industry Co., LTD., New Taipei City (TW)

(72) Inventor: CHI-MING TSENG, New Taipei City (TW)

(21) Appl. No.: 17/229,784

(22) Filed: Apr. 13, 2021

(30) Foreign Application Priority Data
Sep. 9, 2020 (CN) 202021961503.2

(51) Int. Cl. A47J 31/40; A47J 31/44

(52) U.S. Cl. CPC A47J 31/407; A47J 31/4403; A47J 31/4492

(57) ABSTRACT

A drawing-type coffee machine for extracting a coffee capsule with an identification pattern, comprising: a main body; a dynamics assembly arranged in the main body; an extraction assembly connected with the dynamics assembly for containing the coffee capsule, the extraction assembly being driven by the dynamics assembly to slide in the main body or slide out the main body; a cutter assembly arranged above the dynamics assembly; and an optical identification assembly arranged in an outer surface of the main body; wherein, when the extraction assembly is exposed out of the main body, the optical identification assembly identify the identification pattern of the coffee capsule and then provides a driving signal according to the identification pattern, the dynamics assembly is driven according to the driving signal, and when the extraction assembly is driven to slide in the main body, the cutter assembly aligns to the coffee capsule.

### CROSS-REFERENCE TO RELATED APPLICATION

The present application is based on, and claims priority from, China Patent Application No. 202021961503.2, filed Sep. 9, 2020, the disclosure of which is hereby incorporated by reference herein in its entirety.

### BACKGROUND OF THE INVENTION

### 1. Field of the Invention

The present invention relates to a drawing-type capsule coffee machine, in particular to a drawing-type capsule coffee machine which extracts coffee automatically.

### 2. The Related Art

A drawing-type coffee machine is a semi-automatic coffee machine. The drawing-type coffee machine is used to extract coffee by puncturing a coffee capsule which contains coffee powder with a puncture structure and then injecting hot water into the coffee capsule. The operation of the drawing-type coffee machine includes manual procedures. The manual procedures include steps of drawing out an extraction assembly, inserting the coffee capsule into the extraction assembly, pushing back the extraction assembly for extracting coffee, and drawing out the extraction assembly again for ejecting the coffee capsule. Besides, the coffee brewing mode is also manually selected, so there are too many manual steps in the semi-automatic coffee machine.

China Patent No. 104116410 discloses a drawing-type capsule coffee machine. The drawing-type coffee machine has a coffee machine body, a brewing assembly and a driving assembly. The brewing assembly comprises a brewing assembly body and a slide rail, wherein the slide rail extends out of the brewing assembly body in a longitudinal direction and connects with the coffee machine body. The driving assembly comprises a power source arranged on the coffee machine body, a first transmission part connected with the power source, and a second transmission part arranged on the slide rail. The first transmission part is driven by the driving source, and then the first driving part drives the second transmission part. So that the brewing assembly is moved in or out of the coffee machine body.

However, the drawing-type capsule coffee machine is still a semi-automatic drawing-type capsule coffee machine because a step of selecting coffee brewing mode is still operated manually. In addition, a puncturing mechanism of the drawing-type capsule coffee machine is a wide-known technology, which can only puncture the coffee capsule before injecting hot water.

Therefore, it is necessary to provide a drawing-type coffee machine which is capable to extract coffee automatically after putting in the coffee capsule without any manually operation.

### SUMMARY OF THE INVENTION

The objective of the present invention is to provide a drawer capsule coffee machine which extracts coffee automatically.

A drawing-type coffee machine for extracting a coffee capsule with an identification pattern, comprising: a main body; a dynamics assembly arranged in the main body; an extraction assembly connected with the dynamics assembly for containing the coffee capsule, the extraction assembly being driven by the dynamics assembly to slide in the main body or slide out the main body; a cutter assembly arranged above the dynamics assembly; and an optical identification assembly arranged in an outer surface of the main body; wherein, when the extraction assembly is exposed out of the main body, the optical identification assembly identify the identification pattern of the coffee capsule and then provides a driving signal according to the identification pattern, the dynamics assembly is driven according to the driving signal, and when the extraction assembly is driven to slide in the main body, the cutter assembly aligns to the coffee capsule.

In a preferred embodiment, wherein the extraction assembly comprises a extraction base, a capsule slot, a coffee tube, an ejector mechanism and a rubber ring, the capsule slot is positioned in the extraction base, a top end of the coffee tube is arranged in the capsule slot, a bottom end of the coffee tube is penetrated through a bottom of the extraction base, the coffee tube is perpendicular to the extraction base, the ejector mechanism is arranged in the capsule slot, and the rubber ring is arranged on an upper surface of the capsule slot.

In a preferred embodiment, wherein the dynamics assembly comprises a base, a plurality of limiting ribs are extended upward form an upper surface of the base, a plurality of sliding buckles are extended upward and extended toward the limiting ribs from the upper surface of the base, the sliding buckles are positioned at an inner side of the limiting ribs, a sliding space is formed between the limiting ribs and the sliding buckles, at least one sliding base is extended from the extraction base and extended toward the dynamics assembly, the sliding base is arranged in the sliding space.

In a preferred embodiment, wherein the cutter assembly is arranged above the base of the dynamics assembly and surrounded a side of the extraction assembly, the cutter assembly comprises a cutter frame, a plurality of supporting rods, a plurality of supporting bases, a rod securer, a plurality of first elastic elements, a plurality of second elastic elements and a water pipe, the supporting rods are arranged at a left side and a right side of the cutter frame, bottoms of the supporting rods are arranged in the supporting bases respectively, the rod securer is secured at tops of the supporting rods, the first elastic elements are sleeved around top parts of the supporting rods respectively, the second elastic elements are sleeved around bottom parts of the supporting rods respectively, the second elastic elements are longer than the first elastic elements, and the water pipe is connected the cutter frame.

In a preferred embodiment, wherein the cutter frame comprises a platform and two side arms, the side arms are extended downward from two sides of the platform, a blade is arranged at a bottom surface of the platform, a water outlet is penetrated an upper surface and the bottom surface of the platform, the water outlet is formed beside the blade, an end of the water pipe is connected to the water outlet, the blade is more close to the extraction assembly than the water outlet, two driving bars are respectively arranged at inner sides of the side arms which face the extraction assembly.

In a preferred embodiment, wherein two guide grooves are formed at a left side and a right side of the extraction base, each of the guide grooves comprises a first path, a second path, a third path and an end of path, the first path is formed as a groove, the first path is extended obliquely and extended upward, the second path is formed as a horizontal groove, the third path is formed as a groove which is extended obliquely and extended downward, the second path is connected between the first path and the third path, the end of path is formed as a closed end of the third path, the driving bars are engaged with the guide grooves respectively.

In a preferred embodiment, wherein a gear rack is arranged on an upper surface of the sliding base, a motor is arranged on a middle of the upper surface of the base, the motor is arranged at an inner side of the sliding buckles, a connecting shaft is extended from a side of the motor and extended toward the limiting ribs, a driving gear is arranged on the connecting shaft, the driving gear is arranged above the gear rack to mesh with the gear rack, a sliding groove is formed at an inner surface of the sliding base for clamping with the sliding buckles.

In a preferred embodiment, wherein the dynamics assembly comprises a funnel arranged at a front side of the motor, the motor is positioned near a rear side of the extraction assembly, a first perforation is form on the base to penetrate the base, the funnel is arranged in the first perforation, a top end of the funnel is secured at the upper surface of the base, and a bottom end of the funnel is connected to the first perforation and arranged to pass through the base.

In a preferred embodiment, wherein a second perforation is formed at a bottom surface of the extraction base, an inner space is recessed downward from a middle of the upper surface of the capsule slot, a recess is recessed downward form the upper surface of the capsule slot, the recess is positioned at an outer rim of the inner space, the rubber ring is arranged in the recess, a third perforation is formed at a bottom of the inner space to penetrate the bottom of the inner space, the third perforation is aligned with the second perforation, the coffee tube is arranged in the third perforation, the top end of the coffee tube is arranged on an upper surface of the bottom of the inner space, the bottom end of the coffee tube is exposed outside of a bottom surface of the bottom of the inner space, the ejector mechanism comprises an ejector plate, at least one sliding shaft, and a spring, the ejector plate is arranged on the upper surface of the bottom of the inner space, a notch is formed at a side of the ejector plate, the sliding shaft is extended downward from a bottom surface of the ejector plate, the sliding shaft is penetrated through the bottom of the inner space, and the spring is sleeved around the sliding shaft.

In a preferred embodiment, wherein the coffee tube comprises a piercing tip and an outlet end, the piercing tip is formed at the top end of the coffee tube to be positioned at the upper surface of the bottom of the inner space, the outlet end is arranged at the bottom end of the coffee tube to pass through the bottom of the inner space and expose outside the bottom surface of the extraction base.

### BRIEF DESCRIPTION OF THE DRAWINGS

FIG. 1 is a perspective view of a drawing-type coffee machine in this invention, wherein the extraction assembly is slid in a main body.

FIG. 2 is a sectional view of the drawing-type coffee machine along line II-II in FIG. 1.

FIG. 3 is a perspective view of the drawing-type coffee machine, wherein the extraction assembly is slid out the main body.

FIG. 4 is a sectional view of the drawing-type coffee machine along line IV-IV in FIG. 3.

FIG. 5 is an enlarge view of part V in FIG. 4.

FIG. 6 is an exploded view of a dynamics assembly, the extraction assembly and a cutter assembly.

FIG. 7 is another exploded view of the dynamics assembly, the extraction assembly and the cutter assembly.

FIG. 8 is a perspective view of a part of the drawing-type coffee machine.

FIG. 9 is another perspective view of the part of the drawing-type coffee machine in FIG. 8.

FIG. 10 is a perspective vie of a base of the dynamics assembly.

FIG. 11 is a perspective view of a motor of the dynamics assembly.

FIG. 12 is an exploded view of a sliding module.

FIG. 13 is a perspective view of the extraction assembly.

FIG. 14 is another perspective view of the extraction assembly.

FIG. 15 is an exploded view of the extraction assembly.

FIG. 16 is a perspective view of a coffee tube of the extraction assembly.

FIG. 17 is a perspective view of an ejector mechanism of the extraction assembly.

FIG. 18 is an exploded view of the cutter assembly.

FIG. 19 is a perspective view of a cutter frame of the cutter assembly.

FIG. 20 are sectional views of the cutter assembly along line XX-XX in FIG. 6, which shows movements of a driving bar of the cutter assembly.

FIG. 21 are sectional views of the extraction assembly along line XXI-XXI in FIG. 6, which shows movements of the extraction assembly.

### DETAILED DESCRIPTION OF THE PREFERRED EMBODIMENT

Reference will now be made in detail to embodiments, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known methods, procedures, components, and circuits have not been described in detail so as not to unnecessarily obscure aspects of the embodiments.

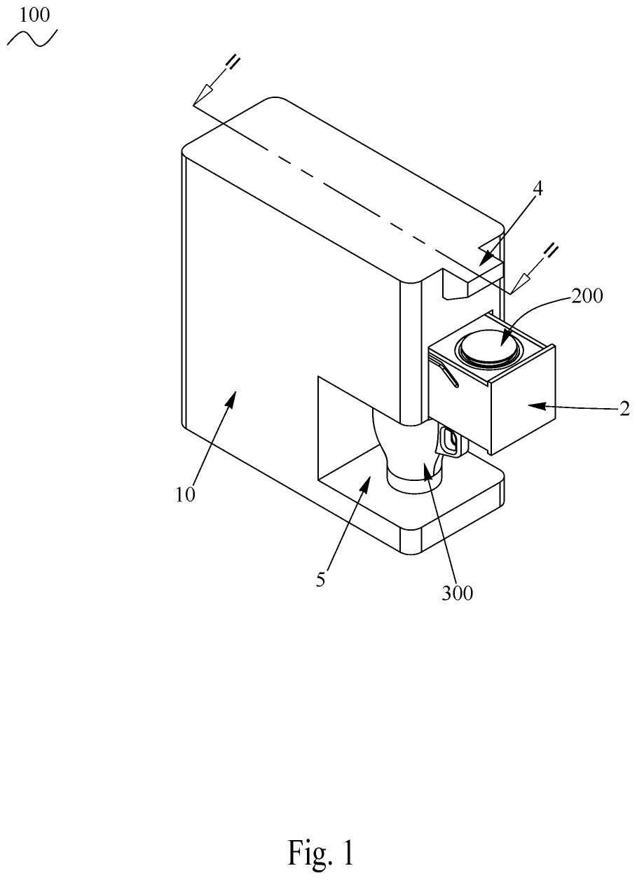

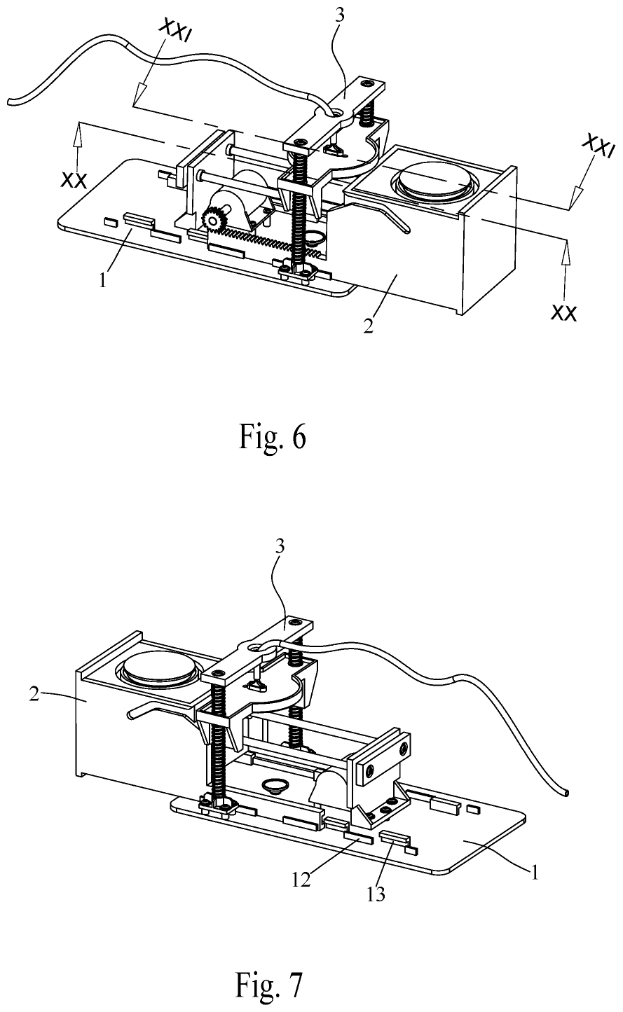

Referring to FIG. 1 to FIG. 4, FIG. 6 and FIG. 7, a drawing-type coffee machine 100 of the present invention comprises a main body 10, a dynamics assembly 1, an extraction assembly 2, a cutter assembly 3, an optical identification assembly 4 and a cup holder 5. The dynamics assembly 1 is disposed in the main body 10. The extraction assembly 2 is disposed in front of the dynamics assembly 1. The extraction assembly 2 is disposed near a front side of the main body 10. The cutter assembly 3 is disposed near a top of the dynamics assembly 1. The cutter assembly 3 surrounds a top and sides of the extraction assembly 2. The optical identification assembly 4 extends outward from a top of the front side of the main body 10. A bottom of the front side of the main body 10 is recessed inwardly to form the cup holder 5. The cup holder 5 is positioned below the dynamics assembly 1. A coffee capsule 200 is placed in the extraction assembly 2, and a coffee cup 300 is placed in the cup holder 5.

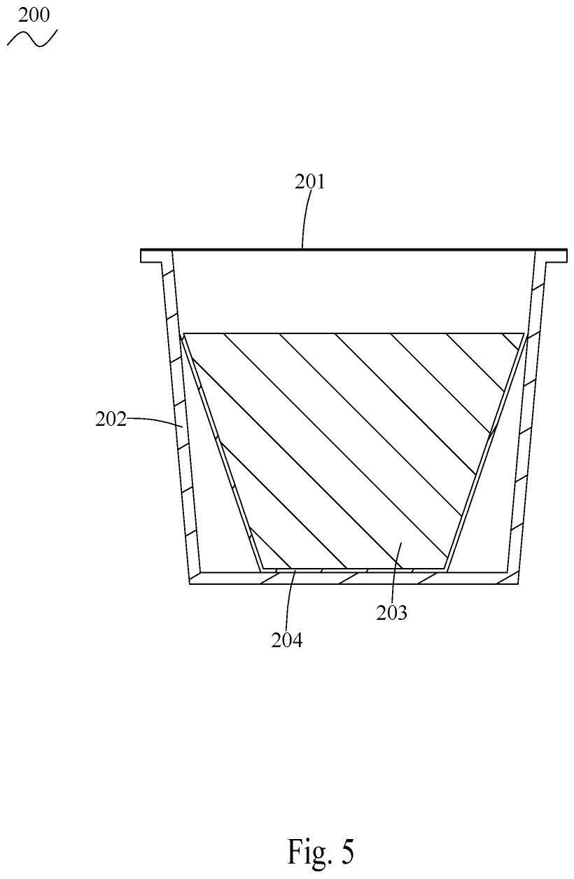

Referring to FIG. 5, the coffee capsule 200 comprises a capsule membrane 201, a capsule case 202, ground coffee 203 and a filter 204. The capsule membrane 201 is arranged on a top of the capsule case 202. The filter 204 is arranged in the capsule case 202. The ground coffee 203 are contained within the filter 204. A brewing mode of the coffee capsule 200 is printed on the capsule membrane 201 as an identification pattern of a QR code in this embodiment. The optical identification assembly 4 identifies the printed identification pattern or the QR code on the capsule membrane 201 and decodes the printed identification pattern or the QR code and provides a driving signal according to the decoded printed identification pattern or the decoded QR code. The dynamics assembly 1 is driven by the driving signal. Therefore, a step of selecting coffee brewing mode is executed automatically by the optical identification assembly 4 of the drawing-type coffee machine 100.

In this embodiment, the dynamics assembly 1 drives the extraction assembly 2 to slide, and a sliding direction of the extraction assembly 2 is perpendicular to the front side of the main body 10. The extraction assembly 2 is arranged as a drawer and arranged to slide in the main body 10 or slide out the main body 10 form the front side of the main body 10 for extracting coffee. In this embodiment, the dynamics assembly 1, the extraction assembly 2, the cutter assembly 3, the optical identification assembly 4 and the cup holder 5 are all arranged on the same side of the main body 10.

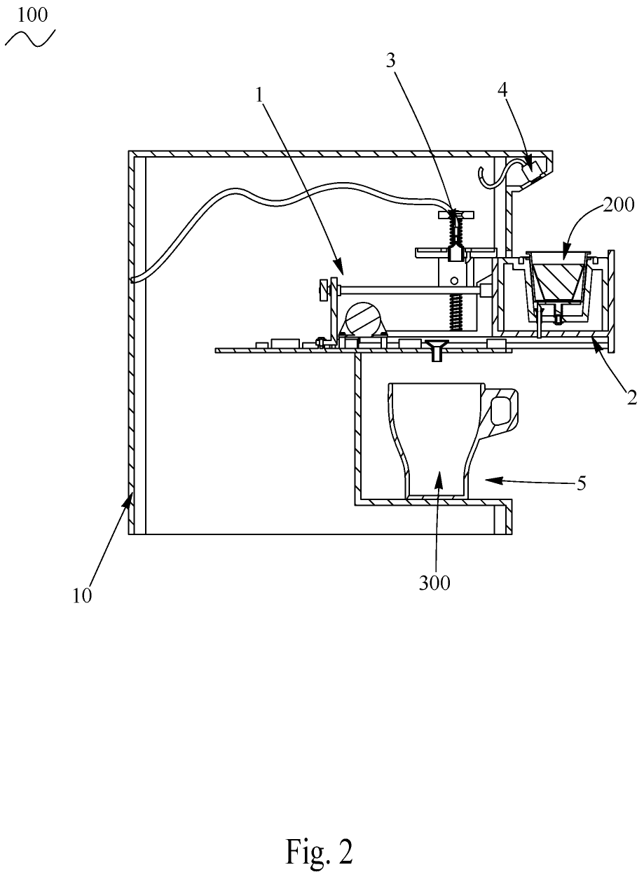

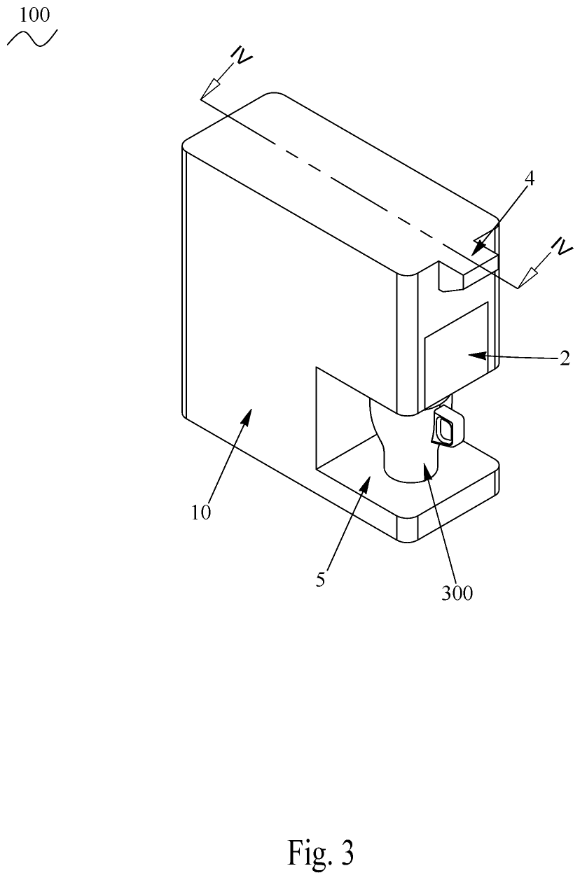

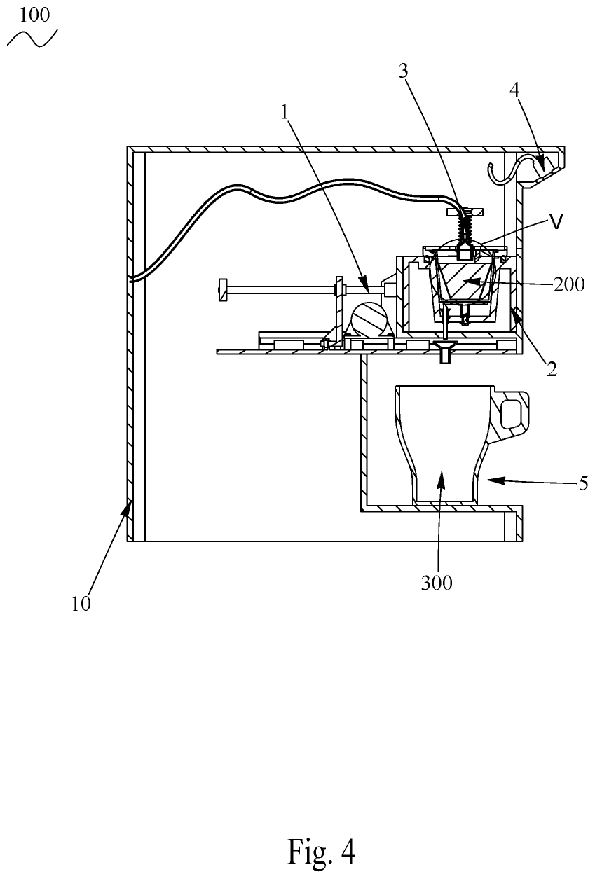

Referring to FIG. 1 and FIG. 2, The dynamics assembly 1 drives the extraction assembly 2 to slide out the main body 10 from the front side of the main body 10 and the optical identification assembly 4 is aligned with the extraction assembly 2 before the drawing-type coffee machine 100 extracts coffee. When the coffee capsule 200 is put in the extraction assembly 2, the optical identification assembly 4 identify the printed identification pattern or the QR code on the capsule membrane 201 and provides the driving signal for driving the dynamics assembly 1. Referring to FIG. 3 and FIG. 4, the dynamics assembly 1 drives the extraction assembly 2 to slide in the main body 10, and then the extraction assembly 2 penetrates into the capsule case 202 of the coffee capsule 200 and enters a bottom of the coffee capsule 200. Meanwhile, the cutter assembly 3 cuts through the capsule membrane 201 of the coffee capsule 200. Then the cutter assembly 3 injects hot water in the coffee capsule 200 for extracting coffee. When a step of extracting coffee is finished, the dynamics assembly 1 drives the extraction assembly 2 to slide out the main body 10.

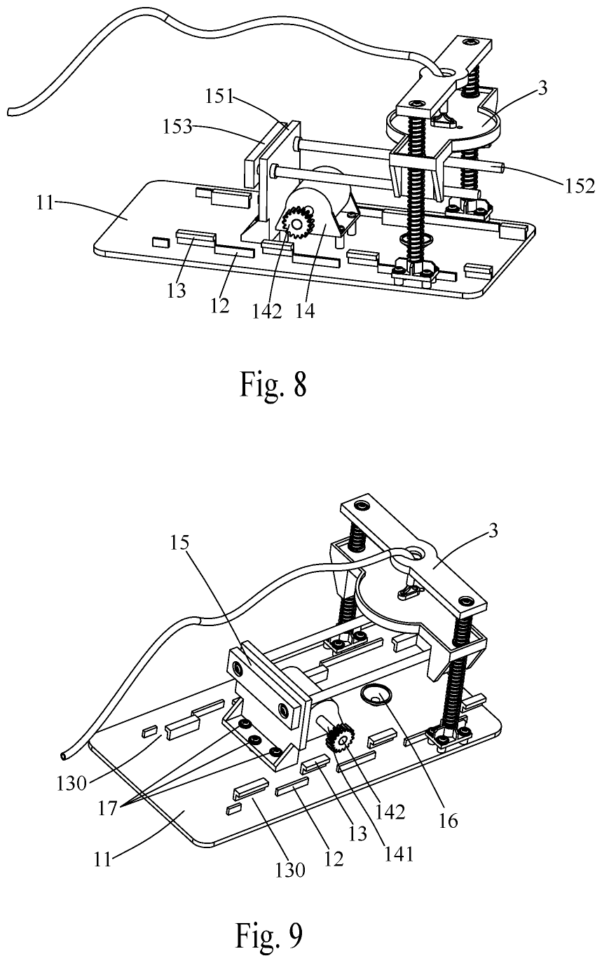

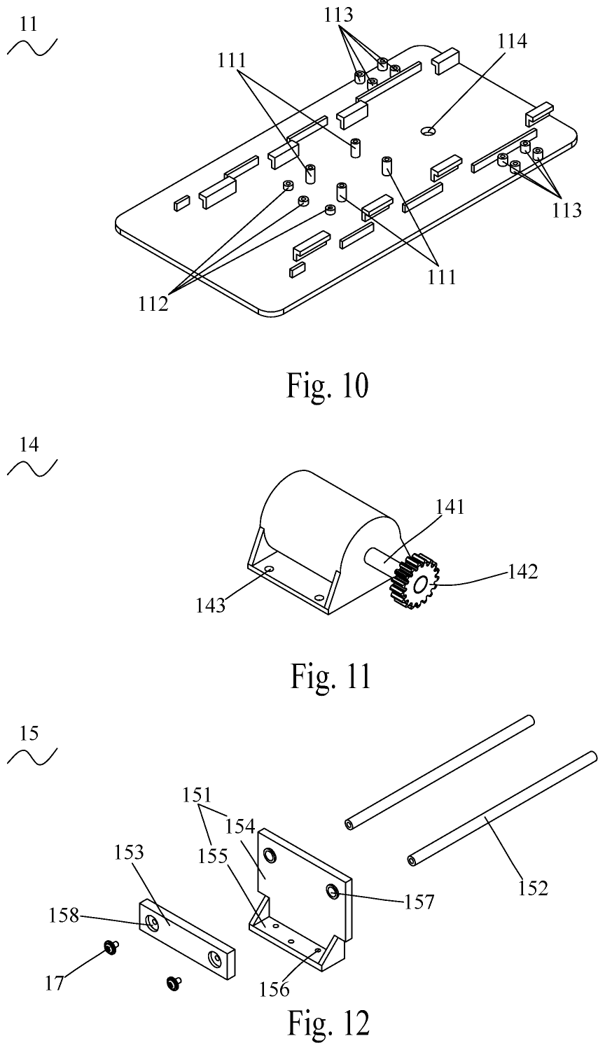

Referring to FIG. 2, FIG. 4, and FIG. 6 to FIG. 12, the dynamics assembly 1 comprises a base 11, a plurality of limiting ribs 12, a plurality of sliding buckles 13, a motor 14, a sliding module 15, a funnel 16 and a plurality of screws 17. The base 11 is arranged above the cup holder 5 and a rear part of the base 11 is located within the main body 10.

A plurality of first positioning posts 111 are extended upward from a middle of an upper surface of the base 11. The first positioning posts 111 are hollow cylinders, and are positioned at an inner side of the sliding buckles 13. The plurality of the screws 17 go through the motor 14, which are fixed in the first positioning posts 111 for securing the motor 14 on the first positioning posts 111. In this embodiment, the quantity of the first positioning posts 111 is four.

A plurality of second positioning posts 112 are extended upward from the upper surface of the base 11. The second positioning posts 112 are positioned at a rear side of the first positioning posts 111 where is away from the extraction assembly 2. The second positioning posts 112 are hollow cylinders and are positioned at the inner side of the sliding buckle 13. The plurality of the screws 17 go through the sliding module 15, which are fixed in the second positioning posts 112 for securing the sliding module 15 on the second positioning posts 112. In this embodiment, the quantity of the second positioning posts 112 is three.

A plurality of third positioning posts 113 are extended upward from the upper surface of the base 11. The third positioning posts 113 are positioned at a front side of the first positioning posts 111 where is near the extraction assembly 2. The third positioning posts 113 are hollow cylinders and are positioned at an outer side of the limiting rib 12. The plurality of the screws 17 go through the cutter assembly 3, which are fixed in the third positioning posts 113 for securing the cutter assembly 3 on the third positioning posts 113. In this embodiment, the third positioning posts 113 are arranged into two groups, each group has four the third positioning posts 113. Therefore, eight the third positioning posts 113 are extended from the base 11. A first perforation 114 is formed to penetrate the base 11, and the funnel 16 is arranged in the first perforation 114.

The plurality of the limiting ribs 12 are extended upward from the upper surface of the base 11. In this embodiment, the limiting ribs 12 are arranged into two parallel rows which are positioned at two sides of the base 11 for limiting the extraction assembly 2 and avoiding the extraction assembly 2 sliding laterally.

The plurality of the sliding buckles 13 are extended upward from the upper surface of the base 11 and then bent toward the limiting ribs 12. The plurality of sliding buckles 13 are parallel positioned at an inner side of the limiting ribs 12. In this embodiment, each of the sliding buckles 13 is arranged between two the limiting ribs 12, the sliding buckles 13 and the limiting ribs 12 are arranged crosswise. Every two of the plurality of the sliding buckles 13 are set in a pair for arranging the sliding buckles 13 into two parallel rows. A sliding space 130 is formed between the limiting ribs 12 and the sliding buckles 13. The sliding buckles 13 clamps with the extraction assembly 2 to keep the extraction assembly 2 sliding in the sliding space 130.

The motor 14 is secured at the middle of the upper surface of the base 11. The motor 14 is positioned at the inner side of the sliding buckles 13 and perpendicular to the sliding buckles 13. In this embodiment, the motor 14 is a servo motor. A side of the motor 14 is extended toward the limiting rib 12 to form a connecting shaft 141, and a driving gear 142 is attached on an end of the connecting shaft 141. The driving gear 142 is arranged above the extraction assembly 2 and aligned with the sliding space 130. The motor 14 includes a plurality of first positioning holes 143. The screws 17 go through the first positioning holes 143, which are fixed in the first positioning posts 111 for securing the motor 14 on the first positioning posts 11. In this embodiment, the quantity of the first positioning holes 143 is four. In this embodiment, when the motor 14 receives a start signal and starts to rotate clock-wise, the driving gear 142 drives the extraction assembly 2 for sliding the extraction assembly 2 toward the dynamics assembly 1. When the motor 14 receives a reverse signal and starts to rotate counter clock-wise, the driving gear 142 drives the extraction assembly 2 for sliding out the extraction assembly 2 from the front side of the main body 10. The driving gear 142 and the connecting shaft 141 can be arranged on any lateral side of the motor 14 in practice.

The sliding module 15 is arranged at a rear side of the motor 14. The sliding module 15 includes a sliding rod holder 151, a plurality of sliding rods 152 and a securer 153. The sliding rod holder 151 is secured on the upper surface of the base 11 and perpendicular to the upper surface of the base 11. The sliding rod holder 151 includes an upper plate 154 and a lower plate 155. The upper plate 154 is connected with the lower plate 155 in a L-shape. A plurality of second positioning holes 156 are formed to penetrate the lower plate 155. The screws 17 go through the second positioning holes 156, which are fixed in the second positioning posts 112 for securing the sliding rod holder 151 on the second positioning posts 112. In this embodiment, the quantity of the second positioning holes 156 is three. A plurality of first through-holes 157 are formed on the upper plate 154. The securer 153 is provided with a plurality of third positioning holes 158 recessed inwardly, and the third positioning holes 158 are corresponding to the plurality of first through-holes 157. A rear end of the sliding rod 152 goes through the first through-hole 157 to be fixed at a front side of the third positioning holes 158. The screws 17 lock the sliding rod 152 from a rear side of the third positioning holes 158. A front end of the sliding rod 152 is fixed on the extraction assembly 2. The sliding module 15 guides the extraction assembly 2 along a predefined path.

The funnel 16 is arranged at a front side of the motor 14 and positioned near the extraction assembly 2. The funnel 16 is arranged in the first perforation 114. An end of the funnel 16 is fixed on the upper surface of the base 11, and the other end of the funnel 16 goes through a bottom surface of the base 11 and extends toward to the cup holder 5. The funnel 16 guides the coffee to the coffee cup 300.

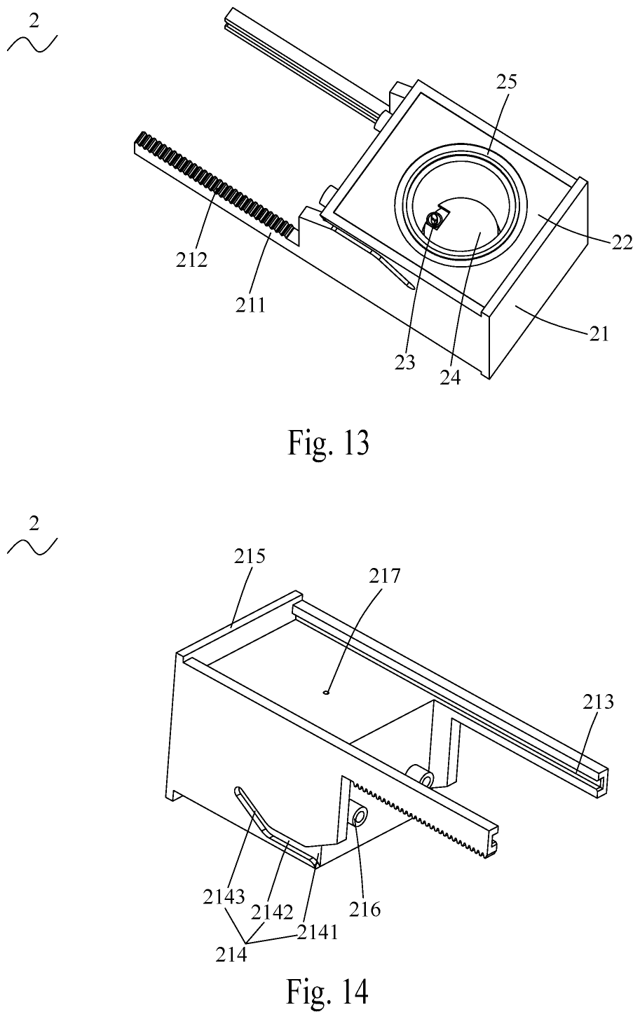

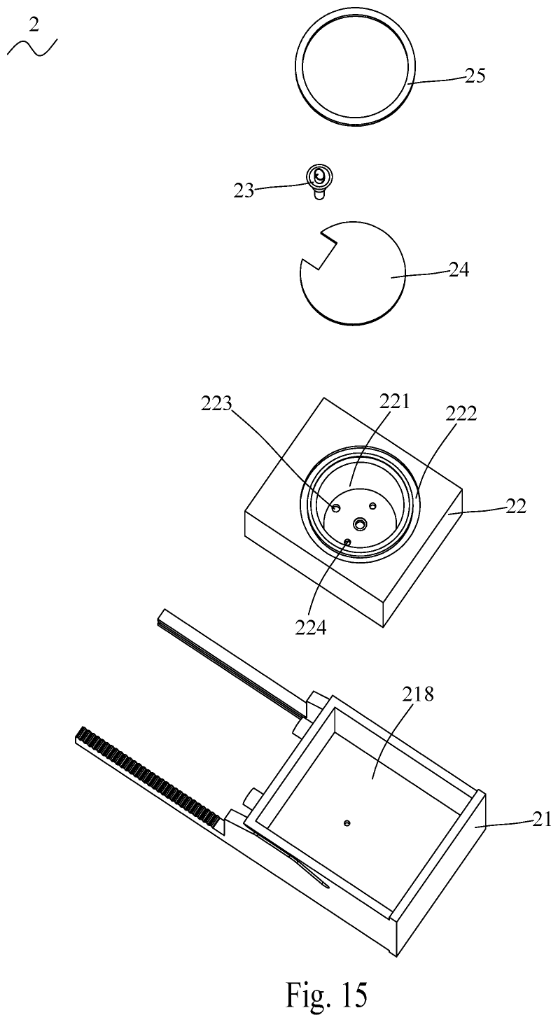

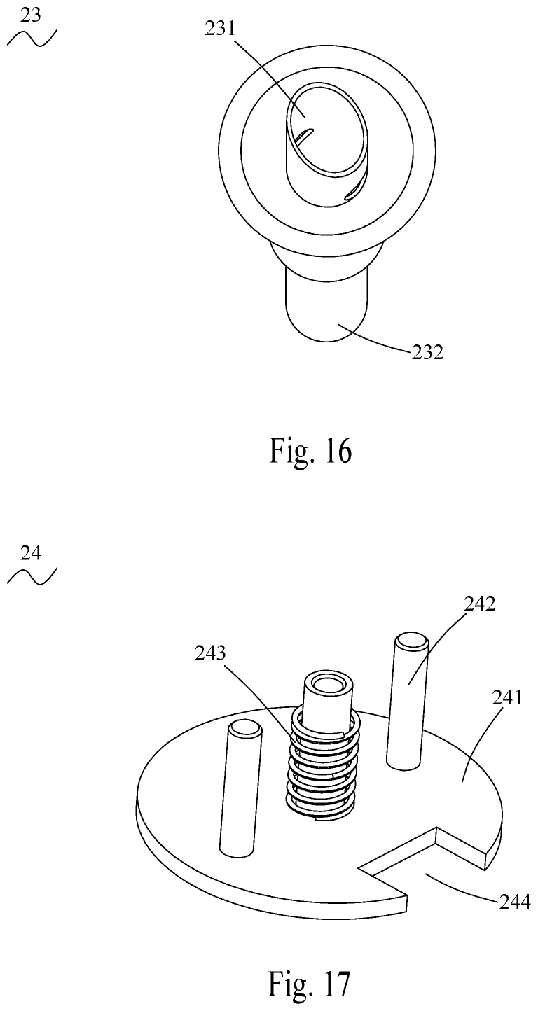

Referring to FIG. 13 to FIG. 17, The extraction assembly 2 includes an extraction base 21, a capsule slot 22, a coffee tube 23, an ejector mechanism 24 and a rubber ring 25. The capsule slot 22 is formed in the extraction base 21. A top end of the coffee tube 23 is arranged in the capsule slot 22 and a bottom end of the coffee tube 23 extends through a bottom surface of the extraction base 21 and toward the funnel 16 for guiding the coffee to the funnel 16. The coffee tube 23 is perpendicular to the extraction base 21. The ejector mechanism 24 is arranged in the capsule slot 22 for ejecting the coffee capsule 200 after the coffee capsule 200 is used. So the user can easily discard the used coffee capsule 200. The rubber ring 25 is arranged on an upper surface of the capsule slot 22 to contact closely with the cutter assembly 3 for preventing the leakage of the steam and hot water.

The extraction base 21 is provided with two sliding bases 211 extended rearward from two sides of the extraction base 21 and toward the dynamics assembly 1. The sliding bases 211 are formed in a long strip shape, and positioned in the sliding space 130 for sliding along the sliding space 130. In this embodiment, a gear rack 212 is arranged on an upper surface of each sliding base 211. The gear rack 212 and the driving gear 142 are positioned on the same side. A recessed sliding groove 213 is formed at an inner side surface of each sliding base 211 for fitting with the sliding buckles 13. The driving gear 142 is arranged on a top of the gear rack 212 to engage with the gear rack 212. In this embodiment, the driving gear 142 drives the gear rack 212 to slide the sliding base 211 along the sliding space 130, meanwhile the extraction assembly 2 is limited by the sliding rod 152 to only move toward the dynamics assembly 1 or move out of the front side of the main body 10. In practice, the upper surfaces of two the sliding bases 211 can be provided with the gear rack 212.

Two recessed guide grooves 214 are formed on two side surfaces of an upper part of the extraction base 21 for guiding the cutter assembly 3. The guide groove 214 includes a first path 2141, a second path 2142, a third path 2143 and an end of path 2144. In this embodiment, the first path 2141 is a groove extended obliquely upward, the second path 2142 is a horizontal groove, the third path 2143 is a groove extended obliquely downward, and the end of path 2144 is a closed end of the third path 2143.

A blocking section 215 is extended downward from a lower part of a front side wall of the extraction base 21 where is close to the front side of the main body 10. The blocking section 215 abuts against the base 11 when the extraction assembly 2 is slid in the main body 10, meanwhile the cutter assembly 3 is engaged with the end of path 2144. A plurality of fourth positioning posts 216 are extended from a rear side of the extraction base 21 where is close to the dynamics assembly 1, the fourth positioning posts 216 are extended toward the dynamics assembly 1. The fourth positioning posts 216 are hollow cylinders. The rear ends of the sliding rods 152 go through the first through-holes 157, which are fixed at the inner side of the third positioning holes 158, and the front ends of the sliding rods 152 is fixed in the fourth positioning posts 216. In this embodiment, the quantity of the fourth positioning post 216 is two. A second perforation 217 is formed at the bottom surface of the extraction base 21. The coffee tube 23 is exposed from the second perforation 217 for guiding the coffee to the funnel 16. A recessed receptacle 218 is formed on an upper surface of the extraction base 21, and the capsule slot 22 is positioned in the receptacle 218.

A recessed inner space 221 is formed on a middle of the upper surface of the capsule slot 22 for containing the coffee capsule 200. A recessed recess 222 is formed on the upper surface of the capsule slot 22 and the recess 222 is positioned at an outer rim of the inner space 221 for containing the rubber ring 25. A third perforation 223 is formed at a bottom of the inner space 221 and penetrated the bottom of the inner space 221. The third perforation 223 is near a front side of the dynamics assembly 1. The third perforation 223 and the second perforation 217 are lined up. The coffee tube 23 is arranged in the third perforation 223, and the top end of the coffee tube 23 is arranged at an upper surface of the bottom of the inner space 221, and the bottom end of the coffee tube 23 goes through the third perforation 223, which is exposed at a bottom surface of the bottom of the inner space 221. A plurality of second through-holes 224 are formed at the bottom of the inner space 221, and the second through-holes penetrate the bottom of the inner space 221. The plurality of second through-holes 224 are positioned in a line and the ejector mechanism 24 are arranged in the second through-holes 224.

The coffee tube 23 includes a piercing tip 231 and an outlet end 232. The piercing tip 231 is formed at a top of the coffee tube 23, which is located on the upper surface of the bottom of the inner space 221 for penetrating the capsule case 202 of the coffee capsule 200. The outlet end 232 is formed at a bottom of the coffee tube 23, which goes through the third perforation 223 and is exposed at the bottom surface of the extraction base 21 for guiding the coffee to the funnel 16.

The ejector mechanism 24 is arranged in the inner space 221 and includes an ejector plate 241, a plurality of sliding shafts 242 and a spring 243. The ejector plate 241 is arranged at the upper surface of the bottom of the inner space 221 and includes a notch 244 arranged at a side of the ejector plate 24. When the ejector mechanism 24 is pressed down, the piercing tip 231 of the coffee tube 23 goes through the notch 244 to penetrate the capsule case 202 of the coffee capsule 200. A plurality of sliding shafts 242 are extended downward from a bottom surface of the ejector plate 241 to fit with the second through-holes 224. In this embodiment, the quantity of the sliding shafts 242 is three. The spring 243 is arranged around a middle one of the sliding shafts 242, and then be fastened with the screw 17 which passes through the bottom surface of the bottom of the inner space 221 and goes toward the ejector plate 241. The spring 243 is compressed as the ejector mechanism 24 being pushed down. When the extraction assembly 2 returns to the original position, the spring 243 will stretch to eject the coffee capsule 200 for the convenience of user to discard the coffee capsule 200.

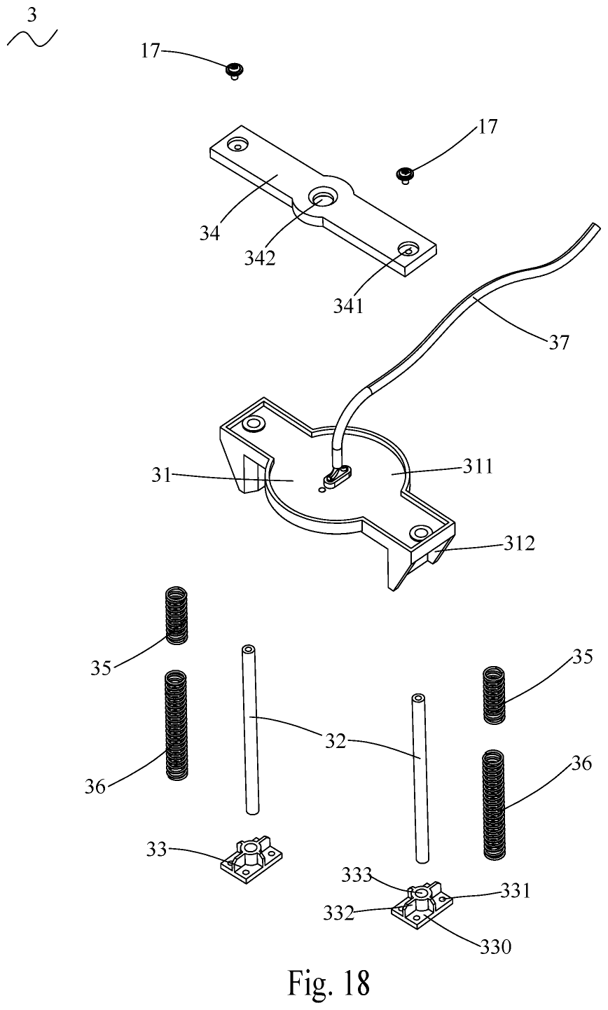

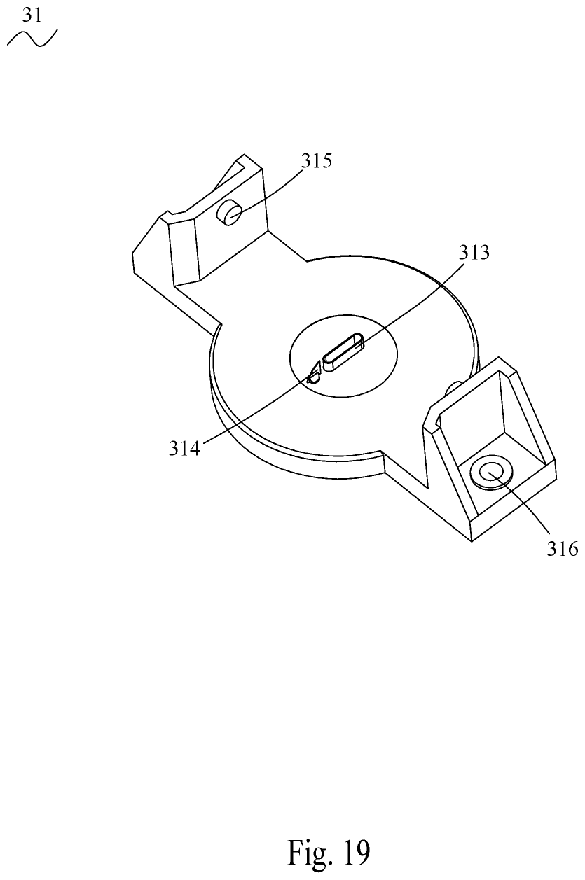

Referring to FIG. 18 and FIG. 19, the cutter assembly 3 is arranged above the base 11 and positioned near the extraction assembly 2. The cutter assembly 3 is arranged to surround a top and two sides of the extraction assembly 2.

The cutter assembly 3 includes a cutter frame 31, a plurality of supporting rods 32, a plurality of supporting bases 33, a rod securer 34, a plurality of first elastic elements 35, a plurality of second elastic elements 36, and a water pipe 37. The plurality of the supporting rods 32 are arranged at two sides of the cutter frame 31 respectively, and a bottom of each supporting rod 32 are arranged in the supporting base 33 for securing the supporting rods 32 with the supporting bases 33. The supporting bases 33 are abut against upper parts of the third positioning post 113 and secured with the screws 17. The rod securer 34 is arranged to secure tops of the supporting rods 32. The first elastic elements 35 are arranged around upper parts of the supporting rods 32. The second elastic elements 36 is arranged around bottom parts of the supporting rods 32. The second elastic elements 36 are longer than the first elastic elements 35, and the elastic force of the first elastic elements 35 and the second elastic elements 36 assists the cutter frame 31 to slide up or slide down. An end of the water pipe 37 is connected to a hot water pump (not shown) in the drawing-type coffee machine 100, and the other end of the water pipe 37 is connected to the cutter frame 31. In this embodiment, the first elastic elements 35 and the second elastic elements 36 are compressing springs.

The cutter frame 31 includes a platform 311 and two side arms 312 extended outward and downward form two sides of the platform 311 symmetrically. A water outlet 313 and a blade 314 are arranged at a bottom surface of the platform 311. The water outlet 313 is penetrated through the platform 311, and the other end of the water pipe 37 is connected with the water outlet 313 for injecting hot water into the coffee capsule 200. The blade 314 is arranged at a side of the water outlet 313 and positioned more closer to the extraction assembly 2 than the water outlet 313 for cutting through the capsule membrane 201 of the coffee capsule 200. Driving bars 315 are extended from an inner surface of each side arm 312 and extended toward the extraction assembly 2. When the driving bars 315 enter the guide grooves 214, the cutter frame 31 will move along the guide grooves 214. A plurality of fourth through-holes 316 are arranged at a joint between the platform 311 and the side arms 312, and the supporting rods 32 pass through the fourth through-holes 316 to secure the cutter frame 31 on the supporting rods 32 and make the cutter frame 31 slide along the supporting rods 32.

The supporting base 33 includes a supporting plate 330, a plurality of fourth positioning hole 331, a rib 332 and a fifth positioning hole 333. The plurality of the fourth positioning holes 331 are formed on the supporting base 33 and penetrated the supporting plate 300. The screws 17 pass through the fourth positioning holes 311, which are secured in the third positioning posts 113 for fastening the supporting bases 33 on the third positioning posts 113. The rib 332 is extended upward from the supporting plate 330, and the fifth positioning hole 333 is formed on a middle of the rib 332. The bottoms of the supporting rods 32 are arranged in the fifth positioning holes 333 for securing the supporting rods 32 with the supporting bases 33.

A plurality of sixth positioning holes 341 are formed at a left side and a right side of the rod securer 34. the tops of the supporting rods 32 are secured at inner sides of the sixth positioning holes 341, and bottoms of the supporting rods 32 are secured in the fifth positioning holes 333 of the supporting bases 33. The supporting rods 32 are fastened by the screws 17 which pass through from top sides of the sixth positioning holes 341. A seventh positioning hole 342 is formed between two the sixth positioning holes 341 and penetrated the rod securer 34. The water pipe 37 passes through the seventh positioning hole 342 to connect the cutter frame 31 and the water outlet 313.

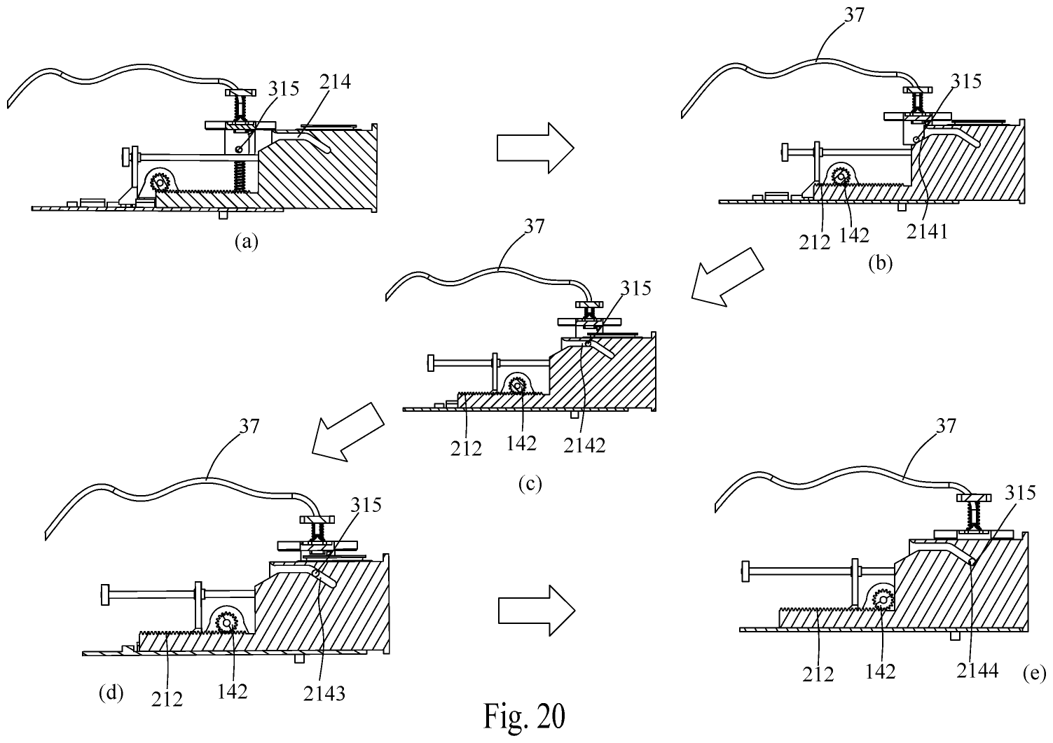

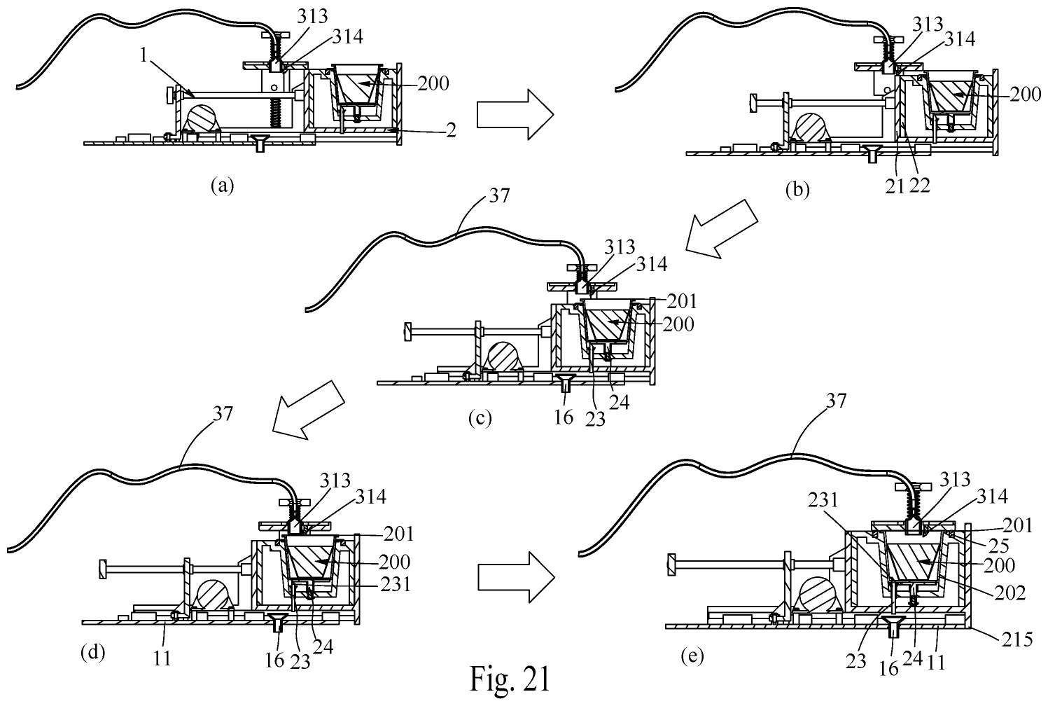

Referring to FIG. 1, FIG. 2, FIG. 20(a) and FIG. 21(a). The dynamics assembly 1 drives the extraction assembly 2 to be exposed outside the front side of the main body 10, and the optical identification assembly 4 aligns the extraction assembly 2 before the drawing-type coffee machine 100 starts to extract coffee. When the coffee capsule 200 is inserted in the extraction assembly 2, the optical identification assembly 4 identifies the printed identification pattern or the QR code on the capsule membrane 201 of the coffee capsule 200, and convents the printed identification pattern or the QR code into the driving signal which drives the dynamics assembly. The dynamics assembly 1 is driven by the driving signal to slide the extraction assembly 2 into the main body 100.

Referring to FIG. 20(b) and FIG. 21(b), when the driving gear 142 drives the gear rack 212 to move a distance, the driving bars 315 enter the guide grooves 214. At first, the driving bars 315 move obliquely and upwardly along the first paths 2141, and the cutter frame 31 gradually moves higher as the extraction assembly 2 slides to avoid the water outlet 313 and the blade 314 from colliding with the extraction assembly 2. And then the extraction assembly 2 continues to slide toward the dynamics assembly 1, and the driving bars 315 enter the second paths 2142 of the guide grooves 214.

Referring to FIG. 20(c) and FIG. 21(c), as the driving bars 315 enter the second paths 2142 of the guide grooves 214, the cutter frame 31 moves to the highest point in the guide grooves 214. So the water outlet 313 and the blade 314 are raised above the capsule membrane 201 of the coffee capsule 200. Then, the extraction assembly 2 continues to slide toward the dynamics assembly 1, and the driving bars 315 enter the third paths 2143 of the guide grooves 214.

Referring to FIG. 20(d) and FIG. 21(d), when the driving bars 315 enter the third paths 2143 of the guide grooves 214, the driving bars 315 move downward along the third paths 2143, and the height of the cutter frame 31 gradually decreases as the extraction assembly 2 gradually moves in the main body 10. The blade 314 scratches the capsule membrane 201 of the coffee capsule 200 at first, and then the water outlet 313 enters coffee capsule 200 through the scratched capsule membrane 201. The extraction assembly 2 continues to slide toward the dynamics assembly 1 till the driving bars 315 reach the ends of path 2144 of the guide grooves 214.

Referring to FIG. 3, FIG. 4, FIG. 20(e) and FIG. 21(e), when the driving bars 315 move to the ends of path 2144 of the guide grooves 214, the motor 14 receives a stop signal and stops operation. The platform 311 of the cutter frame 31 presses the coffee capsule 200 downward so that the piercing tip 231 of the coffee tube 23 pierces the capsule case 202 of the coffee capsule 200 and enters the bottom of the coffee capsule 200. At this moment, the coffee tube 23 and the funnel 16 are on the same line along a top-to-down direction, and the rubber ring 25 contacts with the cutter frame 31 closely to prevent the steam of hot water from escaping. Then the hot water pump (not shown in the figure) of the drawer coffee machine 100 receives a signal and pumps hot water through the water pipe 37 to the water outlet 313. And then hot water is injected into an upper part of the coffee capsule 200 to mixes with the ground coffee ground 203 for extracting coffee. The extracted coffee flows to the bottom of the coffee capsule 200 after the extracted coffee being filtered by the filter 204. The outlet end 232 of the coffee tube 23 guides the extracted coffee to flow toward the funnel 16 and then toward the coffee cup 300 to complete extraction.

When extraction is completed, the motor 14 receives the reverse signal to rotate counter clock-wise, and the driving gear 142 drives the gear rack 212 and the sliding base 211 to slide along the sliding space 130. Guided by the sliding rods 152, the driving bar 315s slide through the third paths 2143, the second paths 2142 and the first paths 2141 in sequence to return the extraction assembly 2 to its initial position. The ejector mechanism 24 ejects the coffee capsule 200 after the coffee capsule 200 is used, for user to pick up and discard easily.

In summary, when the coffee capsule 200 is putted into the extraction assembly 2, the optical identification assembly 4 automatically identify the printed identification pattern or the QR code on the capsule membrane 201 of the coffee capsule 200 and convert the printed identification pattern or the QR code into the driving signal for driving the dynamics assembly 1 to act. After that, the dynamics assembly 1 drives the extraction assembly 2 to slide inside the main body 10. The blade 314 of the cutter assembly 3 cuts the capsule membrane 201 of the coffee capsule 200. The water outlet 313 injects hot water into the upper part of the coffee capsule 200, meanwhile the piercing tip 231 of the coffee tube 23 pierces the capsule case 202 of the coffee capsule 200 to enter the bottom of the coffee capsule 200. The outlet end 232 of the coffee tube 23 guides coffee to flow to the funnel 16 and then to the coffee cup 300. When the extraction is completed, the dynamics assembly 1 drives the extraction assembly 2 out of the main body 10 and return to the initial position, and ejects the used coffee capsule 200 for users to pick up and discard easily. Therefore, the drawing-type coffee machine 100 in this invention is able to extract the coffee capsule automatically without manual operation.

What is claimed is:

1. A drawing-type coffee machine for extracting a coffee capsule with an identification pattern, comprising:
a main body;
a dynamics assembly arranged in the main body;
an extraction assembly connected with the dynamics assembly for containing the coffee capsule, the extraction assembly being driven by the dynamics assembly to slide in the main body or slide out the main body;
a cutter assembly arranged above the dynamics assembly; and
an optical identification assembly arranged in an outer surface of the main body; wherein
when the extraction assembly is exposed out of the main body, the optical identification assembly identify the identification pattern of the coffee capsule and then provides a driving signal according to the identification pattern, the dynamics assembly is driven according to the driving signal; and
when the extraction assembly is driven to slide in the main body, the cutter assembly aligns to the coffee capsule.

2. The drawing-type coffee machine as claimed in claim 1, wherein the extraction assembly comprises a extraction base, a capsule slot, a coffee tube, an ejector mechanism and a rubber ring, the capsule slot is positioned in the extraction base, a top end of the coffee tube is arranged in the capsule slot, a bottom end of the coffee tube is penetrated through a bottom of the extraction base, the coffee tube is perpendicular to the extraction base, the ejector mechanism is arranged in the capsule slot, and the rubber ring is arranged on an upper surface of the capsule slot.

3. The drawing-type coffee machine as claimed in claim 2, wherein the dynamics assembly comprises a base, a plurality of limiting ribs are extended upward form an upper surface of the base, a plurality of sliding buckles are extended upward and extended toward the limiting ribs from the upper surface of the base, the sliding buckles are positioned at an inner side of the limiting ribs, a sliding space is formed between the limiting ribs and the sliding buckles, at least one sliding base is extended from the extraction base and extended toward the dynamics assembly, the sliding base is arranged in the sliding space.

4. The drawing-type coffee machine as claimed in claim 3, wherein the cutter assembly is arranged above the base of the dynamics assembly and surrounded a side of the extraction assembly, the cutter assembly comprises a cutter frame, a plurality of supporting rods, a plurality of supporting bases, a rod securer, a plurality of first elastic elements, a plurality of second elastic elements and a water pipe, the supporting rods are arranged at a left side and a right side of the cutter frame, bottoms of the supporting rods are arranged in the supporting bases respectively, the rod securer is secured at tops of the supporting rods, the first elastic elements are sleeved around top parts of the supporting rods respectively, the second elastic elements are sleeved around bottom parts of the supporting rods respectively, the second elastic elements are longer than the first elastic elements, and the water pipe is connected the cutter frame.

5. The drawing-type coffee machine as claimed in claim 4, wherein the cutter frame comprises a platform and two side arms, the side arms are extended downward from two sides of the platform, a blade is arranged at a bottom surface of the platform, a water outlet is penetrated an upper surface and the bottom surface of the platform, the water outlet is formed beside the blade, an end of the water pipe is connected to the water outlet, the blade is more close to the extraction assembly than the water outlet, two driving bars are respectively arranged at inner sides of the side arms which face the extraction assembly.

6. The drawing-type coffee machine as claimed in claim 5, wherein two guide grooves are formed at a left side and a right side of the extraction base, each of the guide grooves comprises a first path, a second path, a third path and an end of path, the first path is formed as a groove, the first path is extended obliquely and extended upward, the second path is formed as a horizontal groove, the third path is formed as a groove which is extended obliquely and extended downward, the second path is connected between the first path and the third path, the end of path is formed as a closed end of the third path, the driving bars are engaged with the guide grooves respectively.

7. The drawing-type coffee machine as claimed in claim 3, wherein a gear rack is arranged on an upper surface of the sliding base, a motor is arranged on a middle of the upper surface of the base, the motor is arranged at an inner side of the sliding buckles, a connecting shaft is extended from a side of the motor and extended toward the limiting ribs, a driving gear is arranged on the connecting shaft, the driving gear is arranged above the gear rack to mesh with the gear rack, a sliding groove is formed at an inner surface of the sliding base for clamping with the sliding buckles.

8. The drawing-type coffee machine as claimed in claim 7, wherein the dynamics assembly comprises a funnel arranged at a front side of the motor, the motor is positioned near a rear side of the extraction assembly, a first perforation is form on the base to penetrate the base, the funnel is arranged in the first perforation, a top end of the funnel is secured at the upper surface of the base, and a bottom end of the funnel is connected to the first perforation and arranged to pass through the base.

9. The drawing-type coffee machine as claimed in claim 2, wherein a second perforation is formed at a bottom surface of the extraction base, an inner space is recessed downward from a middle of the upper surface of the capsule slot, a recess is recessed downward form the upper surface of the capsule slot, the recess is positioned at an outer rim of the inner space, the rubber ring is arranged in the recess, a third perforation is formed at a bottom of the inner space to penetrate the bottom of the inner space, the third perforation is aligned with the second perforation, the coffee tube is arranged in the third perforation, the top end of the coffee tube is arranged on an upper surface of the bottom of the inner space, the bottom end of the coffee tube is exposed outside of a bottom surface of the bottom of the inner space, the ejector mechanism comprises an ejector plate, at least one sliding shaft, and a spring, the ejector plate is arranged on the upper surface of the bottom of the inner space, a notch is formed at a side of the ejector plate, the sliding shaft is extended downward from a bottom surface of the ejector plate, the sliding shaft is penetrated through the bottom of the inner space, and the spring is sleeved around the sliding shaft.

10. The drawing-type coffee machine as claimed in claim 9, wherein the coffee tube comprises a piercing tip and an outlet end, the piercing tip is formed at the top end of the coffee tube to be positioned at the upper surface of the bottom of the inner space, the outlet end is arranged at the bottom end of the coffee tube to pass through the bottom of the inner space and expose outside the bottom surface of the extraction base.
